(19) United States
(12) Patent Application Publication
(10) Pub. No.: US 2007/0124244 A1
(43) Pub. Date: May 31, 2007

(54) Traffic analyzer and security methods

(75) Inventors: Von A. Mock, Boynton Beach, FL (US); David J. Hayes, Lake Worth, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/288,893

(22) Filed: Nov. 29, 2005

(51) Int. Cl. G06Q 99/00

(52) U.S. Cl. 705/50

(57) ABSTRACT

A system (10) and a method (40) of initiating security measures based on mobile traffic patterns can include monitoring (42) identification information (such as Medium Access Control (MAC) Identification information) for a given network access point (11-18) for mobile wireless devices (23), determining (44) if a pattern of identification information registrations warrants initiation of security measures, and initiating (48) security measures if the pattern of identification information registrations justifies a heightened security level. The method can further determine if a fluctuation in the number of MAC Identifications corresponding to mobile devices within a given area during a predetermined time period matches a profile or pattern indicative of the heightened security level. The method can further maintain a historical database (24) of MAC Identification registrations for a given area during a predetermined time period corresponding to one or more network access points.

### FIELD

This invention relates generally to monitoring systems, and more particularly to an analyzer that monitors traffic patterns of communication devices.

### BACKGROUND

Social interaction within large groups can tend toward inappropriate behavior. The mask of a larger crowd enables individuals to participate in disruptive behaviors that may justify additional vigilance not normally provided to smaller group interactions. This social aspect is evident in a number of events or arenas including sporting events such as basketball, football or soccer games, music concerts, gatherings at public parks, school and college campuses.

### SUMMARY

Embodiments in accordance with the present invention can provide personal security and public safety in public access areas. While not trying to hinder freedoms of expression or other rights, there are growing concerns over undesirable social behaviors by one or more individuals within a group of people. Some embodiments herein can use event and historical data to determine the probability of the occurrence of undesirable activity and provide additional security measures based on such determinations.

In a first embodiment of the present invention, a method of initiating security measures based on mobile traffic patterns can include the steps of monitoring identification information (such as Medium Access Control Identification information) for a given network access point for mobile wireless devices, determining if a pattern of identification information registrations warrants initiation of security measures, and initiating security measures if the pattern of identification information registrations justifies a heightened security level. The method can further determine if a fluctuation in the number of Medium Access Control Identifications corresponding to mobile devices within a given area during a predetermined time period matches a profile or pattern indicative of the heightened security level. The method can further maintain a historical database of Medium Access Control Identification registrations for a given area during a predetermined time period corresponding to one or more network access points. The method can involve monitoring for a predetermined number of Medium Access Control Identification registrations and initiating security measures if a number of Medium Access Control Identification registrations with the given network access point exceeds the predetermined number. The method can further include the step of initiating contact to a guardian contact number if the pattern of Medium Access Control Identification registrations justifies the heightened security level.

In a second embodiment of the present invention, a security system based on wireless mobile traffic patterns can include a historical database coupled to a server and a processor coupled to the server and a wireless local area network. The processor can be programmed to monitor identification information (such as Medium Access Control Identification information) for a given network access point for mobile wireless devices, determine if a pattern of identification information registrations warrants initiation of security measures, and initiate security measures if the pattern of identification information registrations justifies a heightened security level. The processor can be further programmed to determine if a fluctuation in the number of Medium Access Control Identification corresponding to mobile devices within a given area during a predetermined time period matches a profile or pattern indicative of the heightened security level. The processor can also be programmed to maintain a historical database of Medium Access Control Identification registrations for a given area during a predetermined time period corresponding to one or more network access points. The processor can also monitor a predetermined number of Medium Access Control Identification registrations and initiate security measures if a number of Medium Access Control Identification registrations with the given network access point exceeds the predetermined number. The processor can also initiate contact to a guardian contact number if the pattern of Medium Access Control Identification registrations justifies the heightened security level.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a security system for a college campus with access points and security server in accordance with an embodiment of the present invention.

FIG. 2 is a block diagram of a security system coupled to a wireless LAN, PSTN, and a cellular network in accordance with an embodiment of the present invention.

FIG. 3 is a security server record set for access point activity being monitored in accordance with an embodiment of the present invention.

FIG. 4 is a flow chart illustrating a method of abnormal mobile node loading at an access point in accordance with an embodiment of the present invention.

FIG. 5 is block diagram of a wireless device used in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

As discussed above, social interaction within large groups can tend toward inappropriate behavior that merits additional surveillance or security. Being able to determine when a condition based on wireless mobile traffic conditions that is likely to result in undesirable behavior can enable an early warning to alert others to take corrective action. Monitoring of wireless technology traffic and patterns allows for corrective action for possible social mob behaviors.

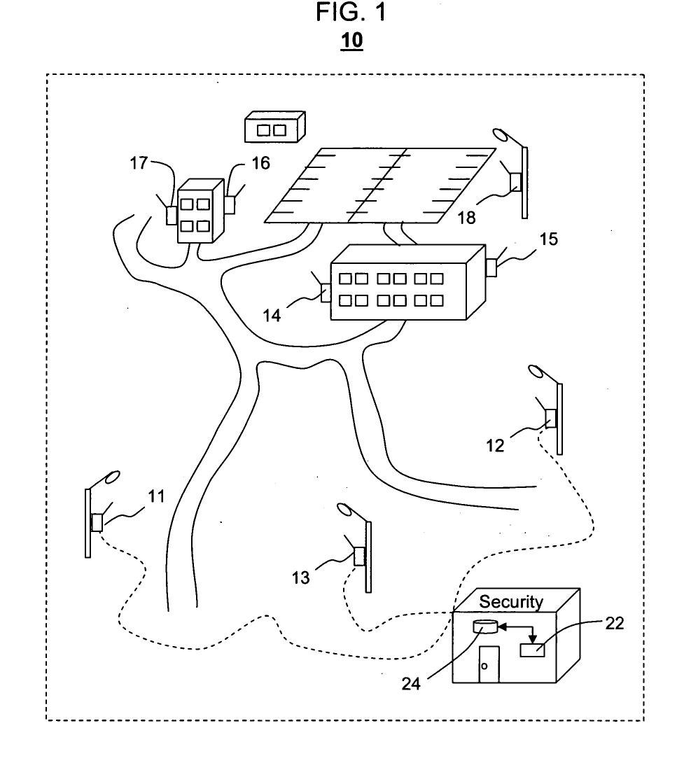

Embodiments herein can provide methods and systems to determine the probability of an undesirable event in a public area. A security system 10 as illustrated in FIG. 1 such as in a college campus setting can use identification information available from devices that connect or register with network access points 11-18 throughout the campus. In this system, wireless access points 11-18 are located on structures including buildings and light poles that both offer access to power and network access. In particular, embodiments herein can use Medium Access Control or MAC Identification (ID) information of each device connected to a network access point to determine how many people (or an estimate of how many people) are within a given area and are connected. Based on the historical data that can be maintained at a database 24 coupled to a security or central server 22, the security system 10 can determine a fluctuation in the number of devices connected or within a given area during a certain time period by monitoring the currently connected devices' MAC Identification. The system 10 can determine if a particular user has a periodicity of being in a given area or one or more individuals are not normally in this given area. This knowledge as well as other aspects is utilized to determine if campus security or other monitoring personal should be sent to a general area. Furthermore, this information can be optionally used to alert a particular user's guardian or parent. Thresholds for alerting campus security or a guardian can be set at the same levels or set at different levels as desired.

Although other forms of identification information such as IP addresses can be used, a MAC ID can likely work quite effectively as contemplated herein. It is also contemplated that devices using future identification sources such as the IPv6 (or Internet Protocol version 6) that has one or more unique IP addresses can be appropriately monitored as contemplated herein. “IP addresses” as contemplated herein should be understood to include IPv4 as well as future Internet Protocol versions such as IPv6. IPv6 will present the opportunity for one device to have one or more routing addresses that like MAC addresses will be unique in the world. Current Internet technology primarily uses IPv4 addressing which is suffering from a growing shortage of IPv4 addresses needed by all new machines added to the Internet. IPv6 fixes a number of problems in IPv4, such as the limited number of available IPv4 addresses and also adds many improvements to IPv4 in areas such as routing and network auto-configuration.

The Medium Access Control Identification or MAC ID is the most basic element in routing of information within a local area network (LAN). Normally the IP address is known externally from a Local Area Network and is commonly used on the Internet to define the destination address. A gateway or other devices normally convert the IP address to the device's actual MAC address which completes the last trip to the device. MAC IDs or addresses are unique within the world and each manufacture of networking equipment is given a range of addresses. These addresses are assigned and coordinated by a central agency to insure uniqueness. Numerous wireless network protocols utilized MAC IDs within the basic hardware and uniquely identify the device. Some of the wireless devices incorporating this technology include 802.11 or WiFi, Bluetooth, 802.15.4, HomeRF, and PowerLine.

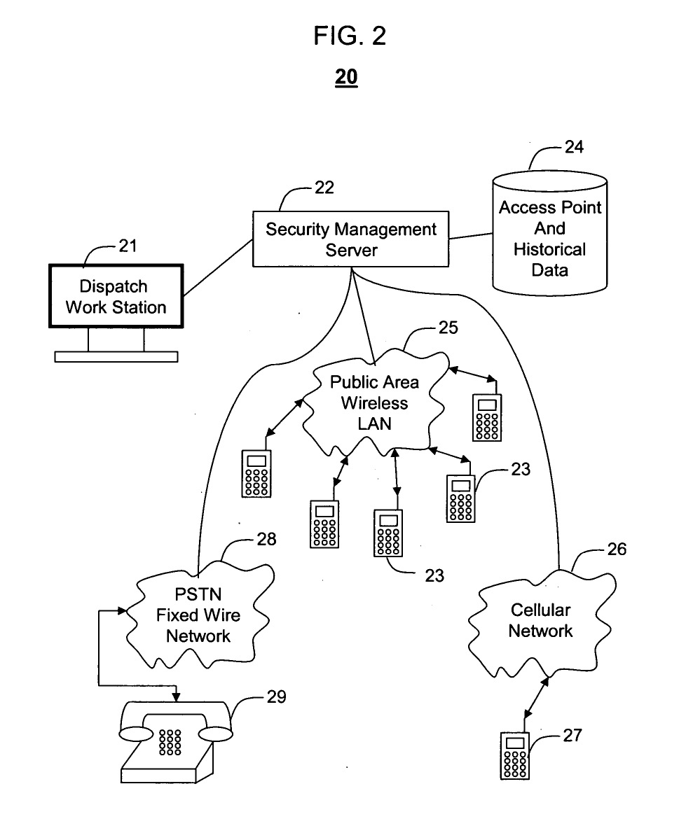

Referring to FIG. 2, another security system 20 in accordance with the embodiments herein is illustrated including the security management server 22, the access point and historical database 24, and a dispatch workstation 21. A public area wireless local area network (WLAN) 25 can be provided in the campus setting (or in other settings) that provides students, faculty and visitors access through their mobile device 23 to the network and Internet while on campus. The dispatch workstation 21 provided in a security office can be monitored for alarm conditions that may exist within the system 20. An alarm condition will cause the dispatch of security personal to the area of concern. The central security or security management server 22 is able to monitor the local area network 25 and the corresponding MAC IDs or other addresses or other information that may be used (e.g. IP addresses). This provides the basis for information to determine undesirable conditions for social mob like interaction. The database 24 can provide historical and current access point MAC ID or other addresses based on time and event information. For example, if the college is providing a special event concert, then the security management server 22 can anticipate that a large number of devices will be expected immediately around or within an auditorium. However, the security management server 22 can flag suspicious behavior of individuals that are around other areas not anticipating a scheduled gathering and which normally do not have a concentration of individuals. As noted above, the security management server 22 can also be programmed to optionally contact specified individuals such as a student's guardian or parent (during an alert condition) that might be available via a PSTN fixed wired network 28 and a home phone 29 or via a cellular network 26 and a cellular phone 27. In another use, other students, faculty or visitors can be informed and avoid potential undesirable social interactions when the security management server determines that a large social group interaction is occurring within an area and security personnel or being dispatched to the area.

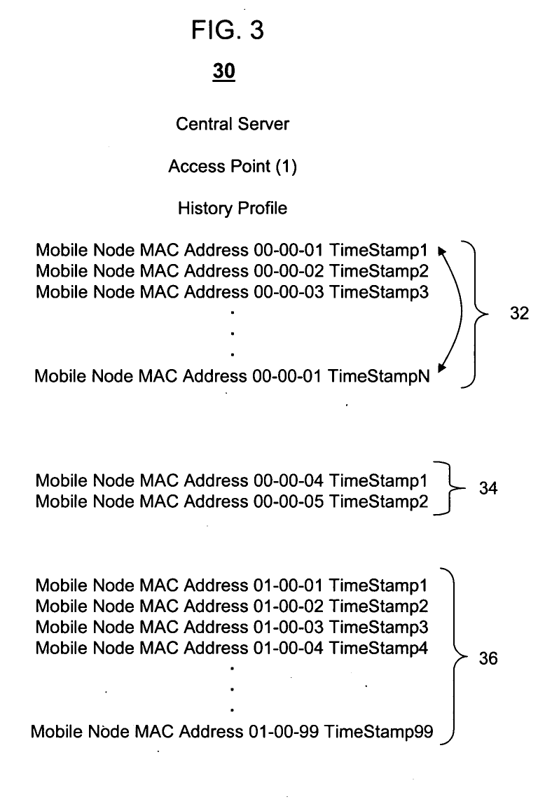

Referring to FIG. 3, a record set 30 is illustrated that is stored in security management database. As seen in the record set 30, the database holds a historical collection of information for each campus access point and each corresponding Device ID (MAC address). For example, normal day activity set 32 and normal night activity set 34 can be determined and compared with for future time periods. For example the last record set 36 in FIG. 3 indicates a large number of individuals are connected or accessing the current access point (1). The security management system can flag this as abnormal or suspect activity (particular if no scheduled gathering is anticipated around such access point) and will dispatch one or more security personal to oversee the social interaction of the crowd. Again, no restrictions are intended on public freedoms or on rights to privacy, but public safety or averting attacks in some instances may outweigh such considerations.

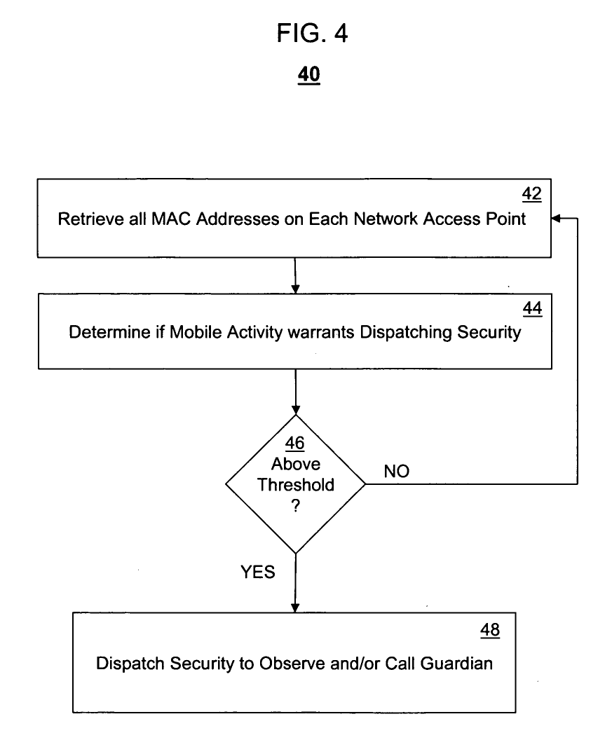

Referring to FIG. 4, a flowchart of a method 40 of initiating security measures based on mobile traffic patterns can include the step 42 of monitoring identification information (such as Medium Access Control Identification information) for a given network access point for mobile wireless devices, determining if a pattern of identification information registrations warrants initiation of security measures at step 44, and initiating security measures at step 48 if the pattern of identification information registrations justifies a heightened security level. The method can further determine if a fluctuation in the number of Medium Access Control Identifications corresponding to mobile devices within a given area during a predetermined time period matches a profile or pattern indicative of the heightened security level. The method can further maintain a historical database of Medium Access Control Identification registrations for a given area during a predetermined time period corresponding to one or more network access points. The method 40 can involve monitoring for a predetermined number of Medium Access Control Identification registrations decision step 46 and initiating security measures if a number of Medium Access Control Identification registrations with the given network access point exceeds the predetermined number. The method 40 can also include at step 48 the step of initiating contact to a guardian contact number if the pattern of Medium Access Control Identification registrations justifies the heightened security level.

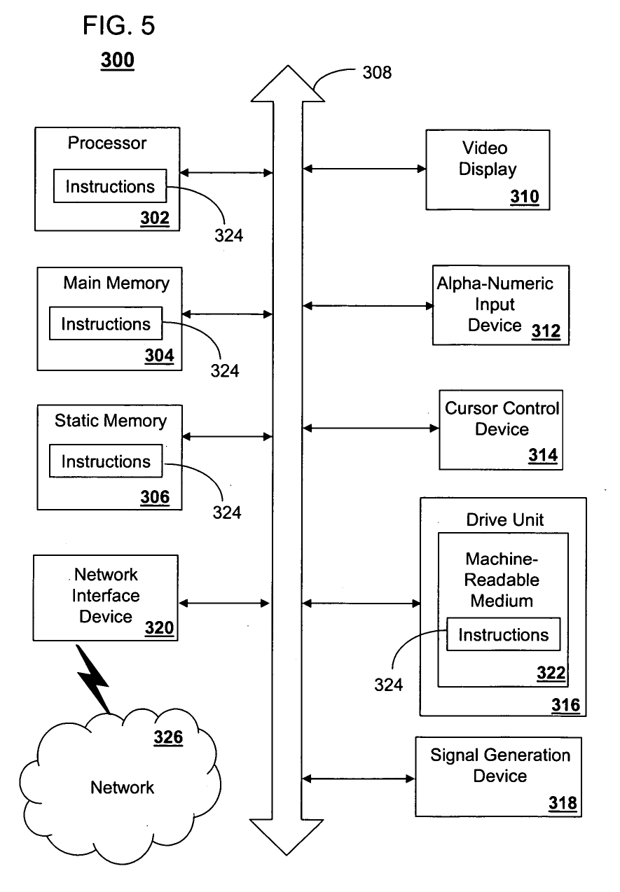

Referring to FIG. 5, an electronic product in the form of a computer system 300 can include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard or keypad), a cursor control device 314 (e.g., a mouse or touchpad), a disk drive unit 316, a signal generation device 318 (e.g., a speaker or remote control or microphone) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of initiating security measures based on mobile traffic patterns, comprising the steps of:
monitoring identification information for a given network access point for mobile wireless devices;
determining if a pattern of identification information registrations warrants initiation of security measures; and
initiating security measures if the pattern of identification information registrations justifies a heightened security level.

2. The method of claim 1, wherein the method further comprises the step of determining if a fluctuation in the number of Medium Access Control Identifications or IP addresses corresponding to mobile devices within a given area during a predetermined time period matches a profile or pattern indicative of the heightened security level.

3. The method of claim 1, wherein the method further comprises the step of maintaining a historical database of Medium Access Control Identification registrations for a given area during a predetermined time period corresponding to one or more network access points.

4. The method of claim 1, wherein the method further comprises the step of monitoring for a predetermined number of Medium Access Control Identification registrations.

5. The method of claim 4, wherein the method further comprises the step of initiating security measures if a number of Medium Access Control Identification registrations with the given network access point exceeds the predetermined number.

6. The method of claim 1, wherein the method further comprises the step of initiating contact to a guardian contact number if the pattern of Medium Access Control Identification registrations justifies the heightened security level.

7. A method of claim 1, wherein the step of monitoring comprises monitoring Medium Access Control Identification information for a given network access point for mobile wireless devices, the step of determining comprises determining if a pattern of Medium Access Control Identification registrations warrants initiation of security measures and the step of initiating comprises initiating security measures if the pattern of Medium Access Control Identification registrations justifies a heightened security level.

8. A security system based on wireless mobile traffic patterns, comprising:
a historical database coupled to a server; and
a processor coupled to the server and a wireless local area network, wherein the processor is programmed to:
monitor identification information for a given network access point for mobile wireless devices;
determine if a pattern of identification information registrations warrants initiation of security measures; and
initiate security measures if the pattern of identification information registrations justifies a heightened security level.

9. The security system of claim 8, wherein the processor is further programmed to determine if a fluctuation in the number of Medium Access Control Identifications or IP addresses corresponding to mobile devices within a given area during a predetermined time period matches a profile or pattern indicative of the heightened security level.

10. The security system of claim 8, wherein the processor is further programmed to maintain a historical database of Medium Access Control Identification registrations for a given area during a predetermined time period corresponding to one or more network access points.

11. The security system of claim 8, wherein the processor is further programmed to monitor a predetermined number of Medium Access Control Identification registrations.

12. The security system of claim 11, wherein the processor is further programmed to initiate security measures if a number of Medium Access Control Identification registrations with the given network access point exceeds the predetermined number.

13. The security system of claim 8, wherein the processor is further programmed to initiate contact to a guardian contact number if the pattern of Medium Access Control Identification registrations justifies the heightened security level.

14. The security system of claim 8, wherein the processor is further programmed to monitor Medium Access Control Identification information for the given network access point, determine if the pattern of Medium Access Control Identification registrations warrants initiation of security measures and initiate security measures if the pattern of Medium Access Control Identification registrations justifies the heightened security level.

15. A machine-readable storage, having stored thereon a computer program having a plurality of code sections executable by a machine for causing the machine to perform the steps of:
monitoring Medium Access Control Identification information for a given network access point for mobile wireless devices;
determining if a pattern of Medium Access Control Identification registrations warrants initiation of security measures; and
initiating security measures if the pattern of Medium Access Control Identification registrations justifies a heightened security level.

16. The machine readable storage of claim 15, wherein the computer program further comprises a plurality of code sections for causing a machine to determine if a fluctuation in the number of Medium Access Control Identifications or IP addresses corresponding to mobile devices within a given area during a predetermined time period matches a profile or pattern indicative of the heightened security level.

17. The machine readable storage of claim 15, wherein the computer program further comprises a plurality of code sections for causing a machine to maintain a historical database of Medium Access Control Identification registrations for a given area during a predetermined time period corresponding to one or more network access points.

18. The machine readable storage of claim 15, wherein the computer program further comprises a plurality of code sections for causing a machine to monitor for a predetermined number of Medium Access Control Identification registrations.

19. The machine readable storage of claim 18, wherein the computer program further comprises a plurality of code sections for causing a machine to initiate security measures if a number of Medium Access Control Identification registrations with the given network access point exceeds the predetermined number.

20. The machine readable storage of claim 15, wherein the computer program further comprises a plurality of code section for causing a machine to initiate contact to a guardian contact number if the pattern of Medium Access Control Identification registrations justifies the heightened security level.
